(19) United States
(12) Patent Application Publication
(10) Pub. No.: US 2026/0355838 A1
(43) Pub. Date: Nov. 12, 2026

(54) BUFFER POWDER AS PRESSURE CONTROL FOR MICRO-BRAZING METALLIC MICROFLUIDIC INTERFACES

(71) Applicant: BRIGHAM YOUNG UNIVERSITY, Provo, UT (US)

(72) Inventors: Robert Davis, Provo, UT (US); Richard Vanfleet, Provo, UT (US); David Hayes, Provo, UT (US); Brian Jensen, Provo, UT (US); Nathan Crane, Provo, UT (US)

(73) Assignee: BRIGHAM YOUNG UNIVERSITY, Provo, UT (US)

(21) Appl. No.: 19/382,174

(22) Filed: Nov. 6, 2025

Related U.S. Application Data
(60) Provisional application No. 63/717,068, filed on Nov. 6, 2024.

(51) Int. Cl. B23K 1/00; B22F 7/06

(52) U.S. Cl. CPC B23K 1/0008; B22F 7/06; B22F 2301/10; B22F 2301/35

(57) ABSTRACT

A microcolumn and capillary are brazed together by applying a first metallic powder to a reservoir surrounding a microcolumn and capillary. The first metallic powder may be sintered. A second metallic powder may be applied over the sintered first metallic powder which may flow through the sintered first metallic powder when heated to braze gaps between a microcolumn and capillary to produce a product of a joined microcolumn and capillary. The microcolumn and capillary may be sized on the order of micrometers and permanently joined using the techniques described herein.

### PRIORITY CLAIM

This application claims the priority and benefit of U.S. Provisional Patent Application No. 63/717,068 filed on Nov. 6, 2024, which is incorporated by reference in its entirety.

### BACKGROUND

Gas chromatography is a technique for analyzing volatile compounds in a mixture. A gas chromatography device separates constituent elements of a volatile compound to analyze amount and types of compounds. Generally, a chromatograph traps a sample of a gas which is passed into a device known as a column through an inlet. A column may be filled a liquid, a solid, or an inert gas which is used to separate the constituent elements of the sample by physical or chemical properties or may provide a capillary, which is a tubular column with a central hole (or lumen) formed through a length of the tube. Tubular capillary columns are more common and generally provide more accurate results than filled columns. The separated elements of the compound are provided to a detector which may include a flame ionization detector and a gas spectrometer. The chromatograph produces a chromatogram which displays a result indicating which compounds are present in the sample.

Chromatographs are extremely useful in a variety of applications, which include environmental conditions, pharmaceuticals, food safety analyses, and forensic science in terms of analyzing samples of fluids to analyze levels of certain compounds in blood or urine. Chromatographs are also used in the petrochemical industry to identify constituent elements of hydrocarbon mixtures. However, in any practical application, accuracy and precision in a chromatograph are critical to conducting a reliable analysis of a volatile compound.

More recent developments with chromatography have reduced the size of columns and have shown that metal columns and capillaries are more robust to thermal cycles with fewer dead volume issues than epoxy, or polymer based columns, capillaries and joints. Most recently, columns are formed on the micrometer scale, with the goal of increasing accuracy and precision. However, forming columns on a micrometer scale has proven to be difficult due to limitations in techniques to join microcolumns to inlet and outlet interfaces. Current technological efforts frequently result in dead-volume (areas that are not connected by braze or other joint filler) problems, thermal instability problems, and leaking problems. These problems not only result in a reduced lifespan for the chromatograph but also reduce the accuracy and precision of the chromatograph. A need exists in the industry to create microcolumns for use in a chromatograph that are more resilient to heat while also keeping the capillary open without leaks and dead-volume inside the microcolumn.

It is therefore one object of this disclosure to provide a method for brazing a microcolumn which prevents filling a capillary in the microcolumn. It is another object of this disclosure to provide a method for brazing a microcolumn which fills gaps between the microcolumn and the capillary. It is another object of this disclosure to provide a first metal powder which may be sintered and a second metal powder which may be a brazing agent to flow through the sintered first metal powder to join the capillary with the column. It is a further object of this disclosure to provide a metal powder which may be precisely measured to flow into gaps between the microcolumn and the capillary without clogging the capillary. It is another object of this disclosure to provide a microcolumn by the methods disclosed herein.

### SUMMARY OF THE DISCLOSURE

Disclosed herein is a method which includes providing a microcolumn and a capillary. The microcolumn and the capillary may be fitted together. A liquified metallic powder may be applied to gaps between the microcolumn and the capillary through a sintered product which brazes the microcolumn to the capillary.

Further provided herein is a product that results from the brazing processes discussed above. For example, a microcolumn with an attached capillary is provided by fitting the microcolumn and the capillary together. Once the microcolumn and the capillary are fitted together, a liquified metallic powder may be applied to gaps between the microcolumn and the capillary through a sintered metallic powder which brazes the microcolumn to the capillary.

### BRIEF DESCRIPTION OF THE DRAWINGS

Non-limiting and non-exhaustive implementations of the disclosure are described with reference to the following figures, wherein like reference numerals refer to like parts throughout the various views unless otherwise specified. The advantages of the disclosure will become better understood with regard to the following description and accompanying drawings where:

FIG. 1 illustrates a microfluidic interface which includes a microcolumn fitted to a capillary in a base.

FIG. 2 illustrates a brazed microfluidic interface having a microcolumn with a connected capillary disposed in a base.

FIG. 3 illustrates a method for brazing a microcolumn to a capillary to form a microfluidic interface.

FIG. 4 illustrates a second method for brazing a microcolumn to a capillary to form a microfluidic interface.

### DETAILED DESCRIPTION

In the following description of the disclosure, reference is made to the accompanying drawings, which form a part hereof, and which are shown by way of illustration-specific implementations in which the disclosure may be practiced. It is understood that other implementations may be utilized, and structural changes may be made without departing from the scope of the disclosure.

In the following description, for purposes of explanation and not limitation, specific techniques and embodiments are set forth, such as particular techniques and configurations, in order to provide a thorough understanding of the device disclosed herein. While the techniques and embodiments will primarily be described in context with the accompanying drawings, those skilled in the art will further appreciate that the techniques and embodiments may also be practiced in other similar devices.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to particular embodiments are not restricted to only those embodiments in which they are described. For example, an element described in reference to one embodiment or figure may be alternatively included in another embodiment or figure regardless of whether or not those elements are shown or described in another embodiment or figure. In other words, elements in the figures may be interchangeable between various embodiments disclosed herein, whether shown or not.

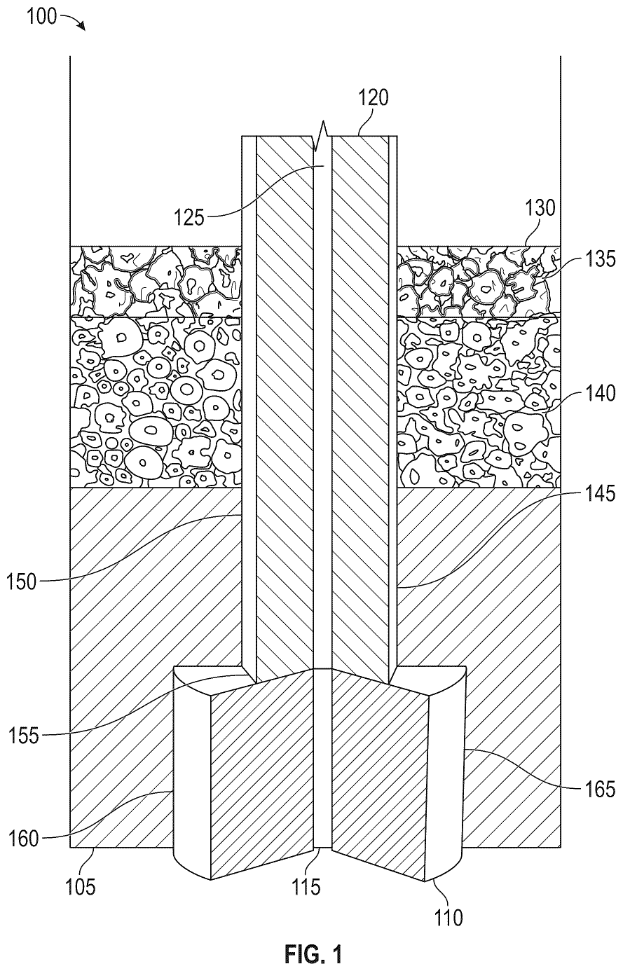

FIG. 1 illustrates a microfluidic interface 100 which includes microcolumn 110 fitted to a capillary 120 in a base 105. As shown in FIG. 1, microcolumn 110 is positioned in close proximity to capillary 120. Here, close proximity means an interstitial gap, such as annular gap 155, which is a distance small enough that brazing microcolumn 110 and capillary 120 can be accomplished using the techniques herein. Base 105 may be sized to accept both microcolumn 110 and capillary 120 and allow both to be fitted together within base 105. Preferably, base 105, microcolumn 110, and capillary 120 are constructed from a metal such as steel, stainless steel, tungsten, titanium, brass, or any other metal or metal alloy that can be brazed. Metal in base 105 may be removed using conventional techniques to accept microcolumn 110 and capillary 120 into base 105.

Both microcolumn 110 and capillary 120 may further be tubular in shape, having a lumen 115/125 which extends through microcolumn 110 and capillary 120. In practice, lumen 115/125 may be tens to hundreds of centimeters in length inside a microfabricated device. Base 105 may be machined or constructed in a manner which fits microcolumn 110 and capillary 120 together such that lumen 115 in microcolumn 110 and lumen 125 in capillary 120 are disposed concentrically to each other when fitted together in base 105, as shown in FIG. 1. Lumen 115 and lumen 125 may be unobstructed throughout microcolumn 110 and capillary 120 and allow gasses or fluids to flow through lumen 115 and lumen 125 during chromatographic use.

Base 105 may include a reservoir 130 which may surround capillary 120 as capillary 120 extends from base 105 into reservoir 130. As shown in FIG. 1, a first metallic powder 140 may be disposed in reservoir 130 along with a second metallic powder 135. In one example, first metallic powder 140 may be a metal or metal alloy in a powder form, which includes, for example, steel, stainless steel, tungsten, titanium, brass, or any other metal or metal alloy that can be brazed. Second metallic powder 135 may also be a metal or metal alloy in powder form, which includes, for example, copper, copper alloys such as brass, tin, lead, zinc, or any other metal which is used to as a braze product to fill gaps in a brazing process. First metallic powder 140 and may be powdered to a size of 45 to 180 micrometers. Further, for clarification, first metallic powder 140 and second metallic powder 135 are illustrated in FIG. 1 for purposes of description of techniques discussed herein. Metallic powders do not constitute a part or portion of the microfluidic interface 100 apparatus or product resulting from processes described herein.

When microcolumn 110 is fitted to capillary 120 within base 105, regardless of the exactness of machining, gaps will be left between microcolumn 110 and base 105 and between capillary 120 and base 105. These gaps are empty space within base 105, which are intended to be filled with brazing material during a brazing process. As shown in FIG. 1, gap 145 and gap 150 may be gaps around an outside circumference of capillary 120 while gap 160 and gap 165 may be gaps around a circumference of microcolumn 110. Gap 145, gap 150, gap 160, and gap 160 are all intended to be filled with braze material. Annular gap 155 may be a gap between microcolumn 110 and capillary 120 which is illustrated as being annular in shape (but not limited to being round, circular, or tubular) due to the tubular shape of capillary 120. Annular gap 155 is also intended to be filled with braze material which permanently attaches capillary 120 to microcolumn 110 in a manner which does not occlude lumen 115 or lumen 125 in either microcolumn 110 or capillary 120. Because microcolumn 110 and capillary 120 are typically small, on the order of micro-meters (e.g., a bore diameter of 100 micrometers) in size, conventional brazing techniques are insufficient to join capillary 120 and microcolumn 110 in a manner that preserves an unobstructed lumen 115/125 in microfluidic interface 100. Novel techniques for performing the brazing process are discussed below which result in a consistent and hermetically sealed braze without dead volume air spaces in the brazed interfaces.

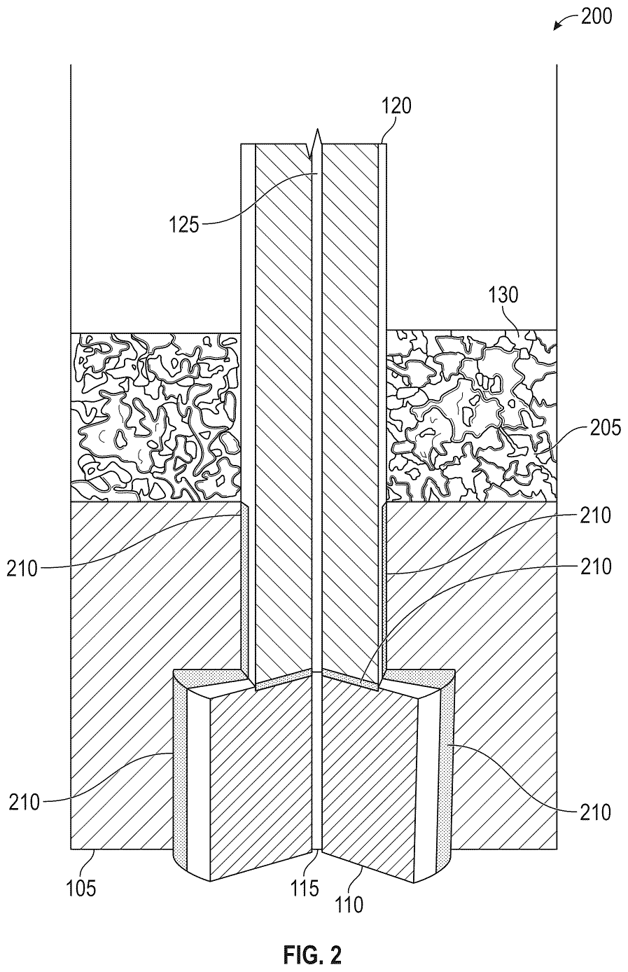

FIG. 2 illustrates a brazed microfluidic interface 200 having a microcolumn 110 with a connected capillary 120 disposed in a base 105. In plain terms, FIG. 2 illustrates microfluidic interface 100 after brazing has been performed to form a brazed microfluidic interface 200. Both microcolumn 110 and capillary 120 may be tubular in shape, having a lumen 115/125 which extends through microcolumn 110 and capillary 120. Base 105 may be machined or constructed in a manner which fits microcolumn 110 and capillary 120 together such that lumen 115 in microcolumn 110 and lumen 125 in capillary 120 are disposed concentrically to each other when fitted together in base 105, to provide an unobstructed joined lumen 115/125. Lumen 115 and lumen 125 may be unobstructed throughout microcolumn 110 and capillary 120 and allow gasses or fluids to flow through lumen 115 and lumen 125 during chromatographic use.

Base 105 may include a reservoir 130 which may surround capillary 120 as capillary 120 extends from base 105 into reservoir 130. As shown in FIG. 2, first metallic powder 140 has been sintered to form a metallic matrix or substrate 205. A subsequent brazing step melted second metallic powder 145 to flow into gap 145, gap 150, gap 160, and gap 155. Second metallic powder 145 further flows into annular gap 155 to braze microcolumn 110 to capillary 120. As shown in FIG. 2, each one of gap 145, gap 150, gap 160, and annular gap 155 have been filled with braze, shown as braze interfaces 210.

In practice, a microfluidic interface 200 may be formed by providing a microcolumn 110 and a capillary 120 fitted together within a base 105. A first metallic powder 140, shown in FIG. 1, may be applied to reservoir 130 of the base and be formed from the same metal that the microcolumn 110 and capillary 120 are formed from. First metallic powder 140 may then be sintered in reservoir 130 by exposing microfluidic interface 100, shown in FIG. 1, to a heat which causes first metallic powder 140 to form a metallic matrix or substrate 205 having pores up to 100 micrometers in circumference. The metallic matrix or substrate forms a powder bed which may receive second metallic powder 135.

Microfluidic interface 100 may then be exposed to heat in a low pressure environment, which uses capillary action in pores of the metallic matrix/substrate 205 to draw the liquified second metallic powder (now braze) into gap 145, gap 150, gap 160, gap 165, and annular gap 155 shown in FIG. 1 resulting in brazed interfaces 210, as shown in FIG. 2. First metallic powder 140 maintains capillary pressure between a gap pressure of gap 145, gap 150, gap 160, gap 165, and annular gap 155 and pressure in the lumen. The capillary pressure of first metallic powder 140, and resulting matrix/substrate 205 depends on size of the powder and saturation level. The capillary action of the reduced pressure environment allows braze (liquified metallic powder) to flow through into any gap until such time as a gap is filled with braze because filling the gap reduces capillary pressure that draws the braze into the gap in the first place. The ideal capillary pressure may be determined according to the following equation:

$${P}_{c} = - \frac{2 σ cos ( θ )}{a}$$

where P_{c} is the ideal pressure for causing the braze to flow, σ is the surface tension of the melted braze (1.23 N/m at 1200 °C), θ is the contact angle of the braze to a solid surface, and a is the gap length or microcolumn radius to be filled by the braze material. In the example of FIG. 2, a pressure of between a maximum of −1293 kPa and a minimum of −172 kPa based on maximum and minimum annular gaps 155 for model testing. Microfluidic interface 200 may be the resulting product, which includes a microcolumn 110 brazed to a capillary 120 and having a clear and unobstructed lumen 115/125 extending through microcolumn 110 and capillary 120. It is noted that the resulting microfluidic interface product 200 may be removed from base 105 in practice. Techniques to remove microfluidic interface product 200 may include machining base 105 away from microcolumn 110 and capillary 120, pressure applied to capillary 120 on reservoir 130 side of base 105, or any other method known in the art.

In another practical example, a microfluidic interface 200 may be formed by providing a microcolumn 110 and a capillary 120 fitted together within a base 105. A metallic powder 135, shown in FIG. 1, may be applied to reservoir 130 of the base and formed from a brazing metal including, for example, brass, copper, tin, lead, zinc, or other similar metals. In this example, a precisely measured amount of metallic powder 135 is placed in reservoir 130. The metallic powder is heated to cause the braze to flow into gap 145, gap 150, gap 160, gap 165, and annular gap 155 shown in FIG. 1 to braze microcolumn 110 and capillary 120 together. The precisely measured amount of powder is calculated to be sufficient to fill all of gap 145, gap 150, gap 160, gap 165, and annular gap 155 with braze (liquified metallic powder 135) without clogging lumen 115/125 in microcolumn 110 and capillary 120. In other words, a precise amount of braze is calculated to only fill gap 145, gap 150, gap 160, gap 165, and annular gap 155 without providing any excess braze which could obstruct lumen 115/125. While no pressure is needed to accomplish a hermetically sealed and consistent braze, this method is more likely to leave dead air volumes in gap 145, gap 150, gap 160, gap 165, and annular gap 155 based on lab testing.

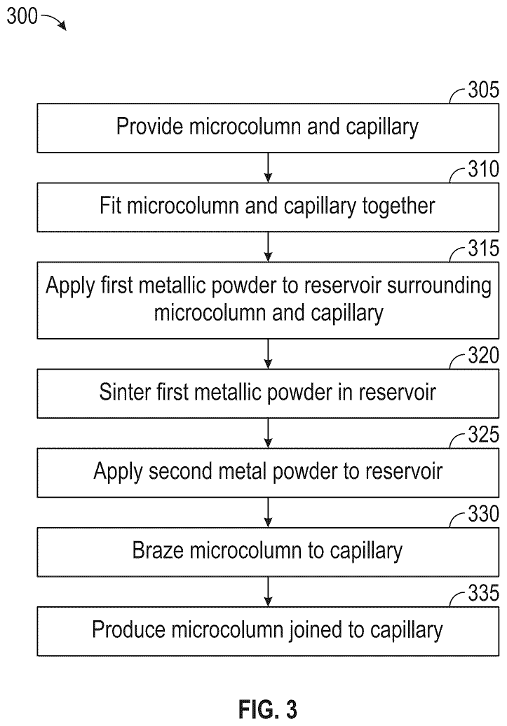

FIG. 3 illustrates a method 300 for brazing a microcolumn to a capillary to produce a microfluidic interface. Method 300 starts at step 305 where a microcolumn and capillary are provided. A microcolumn and capillary may be fit together at step 310 such that an interior lumen in both the microcolumn and capillary are concentrically located by the interior lumen to provide an unobstructed hole/lumen through the microcolumn and capillary. Step 310 may be accomplished by use of a base. At step 315, a first metallic powder may be applied to a reservoir surrounding the microcolumn and the capillary. The reservoir in step 315 may or may not be provided as part of the base of step 310. The first metallic powder may be sintered by heat applied to the reservoir and base at step 320. Sintering may be accomplished by use of a furnace, oven, or another heat source. Once the first metallic powder is sintered at step 320, a metallic matrix or substrate is formed in the reservoir. At step 325, a second metal powder is applied to the reservoir. The second metal powder may be a brazing powder. At step 330, the microcolumn and capillary may be brazed together by reducing ambient atmosphere and heating the second metal powder and allowing capillary pressure to fill gaps between the microcolumn and the capillary (as discussed above) with braze material. A microcolumn brazed to a capillary may be a resultant product of method 300 at step 335.

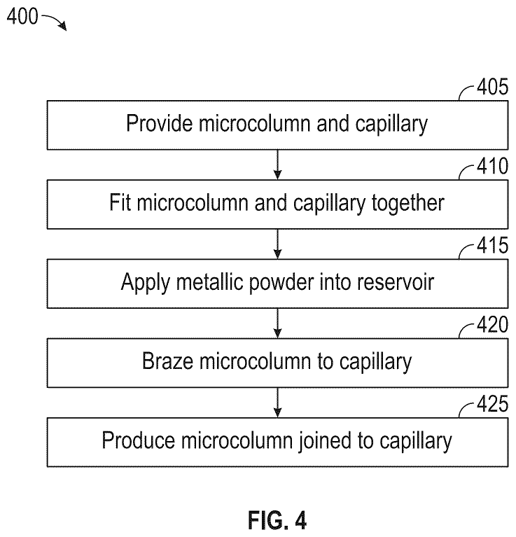

FIG. 4 illustrates a second method 400 for brazing a microcolumn to a capillary in a microfluidic interface. Method 400 starts at step 405 where a microcolumn and capillary are provided. A microcolumn and capillary may be fit together at step 410 such that an interior lumen in both the microcolumn and capillary are concentrically located by the interior lumen to provide an unobstructed hole/lumen through the microcolumn and capillary. Step 410 may be accomplished by use of a base. At step 415, a metallic powder may be applied to a reservoir surrounding the microcolumn and the capillary. The reservoir in step 415 may or may not be provided as part of the base of step 410. The metallic powder may be precisely measured by weight to fill gaps between the microcolumn and capillary. At step 420, the microcolumn and capillary may be brazed together by heating the metallic powder, the microcolumn and the capillary to allow braze material to flow into gaps between the microcolumn and the capillary. Heating may be done in a furnace, oven, or other heat source. Once cooled, at step 425, a resultant product of method 400 is a microcolumn joined to a capillary.

Although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. A method, comprising:
providing a microcolumn and a capillary;
fitting microcolumn and capillary together within a base;
applying a first metallic powder to a reservoir within the base, the first powder surrounding the capillary in the reservoir;
sintering the first metallic powder in the reservoir of the base to form a metallic substrate;
applying a second metal powder to the reservoir on the metallic substrate; and
brazing the microcolumn to the capillary.

2. The method of claim 1, further comprising applying heat to the second metal powder in the reservoir.

3. The method of claim 2, further comprising reducing atmospheric pressure around the base.

4. The method of claim 3, wherein the second metallic powder is liquified and passes through pores in the metallic substrate.

5. The method of claim 4, wherein the liquefied metallic powder flows into one or more gaps between the base and the capillary.

6. The method of claim 5, wherein the liquified metallic powder flows into one or more gaps between the base and the microcolumn.

7. The method of claim 6, wherein the liquified metallic powder flows into a gap between the micro column and the capillary.

8. The method of claim 7, wherein the gap is an annular gap.

9. The method of claim 7, wherein the microcolumn and the capillary are brazed together and maintain an unobstructed lumen extending through the microcolumn and the capillary.

10. The method of claim 7, wherein the base, the microcolumn, and the capillary are formed from stainless steel, the first metallic powder is stainless steel metallic powder, and the second metallic powder is copper metallic powder.

11. A product formed by a process, the process comprising:
providing a microcolumn and a capillary;
fitting microcolumn and capillary together within a base;
applying a first metallic powder to a reservoir within the base, the first powder surrounding the capillary in the reservoir;
sintering the first metallic powder in the reservoir of the base to form a metallic substrate;
applying a second metal powder to the reservoir on the metallic substrate; and
brazing the microcolumn to the capillary to form a microfluidic interface.

12. The product formed by the process of claim 11, further comprising applying heat to the second metal powder in the reservoir.

13. The product formed by the process of claim 11, further comprising reducing atmospheric pressure around the base.

14. The product formed by the process of claim 13, wherein the second metallic powder is liquified and passes through pores in the metallic substrate.

15. The product formed by the process of claim 14, wherein the liquefied metallic powder flows into one or more gaps between the base and the capillary.

16. The product formed by the process of claim 14, wherein the liquified metallic powder flows into one or more gaps between the base and the microcolumn.

17. The product formed by the process of claim 14, wherein the liquified metallic powder flows into a gap between the micro column and the capillary.

18. The product formed by the process of claim 17, wherein the gap is an annular gap.

19. The product formed by the process of claim 17, wherein the microcolumn and the capillary are brazed together and maintain an unobstructed lumen extending through the microcolumn and the capillary in the microfluidic interface.

20. The product formed by the process of claim 11, wherein the base, the microcolumn, and the capillary are formed from stainless steel, the first metallic powder is stainless steel metallic powder, and the second metallic powder is copper metallic powder.
